(19) United States
(12) Patent Application Publication
(10) Pub. No.: US 2026/0313765 A1
(43) Pub. Date: Oct. 8, 2026

(54) ELECTRONIC DEVICE WITH INLINE LOAD METERING VERIFICATION PORT

(71) Applicant: UBICQUIA, INC., FORT LAUDERDALE, FL (US)

(72) Inventors: Ivan Quiroz, Dallas, TX (US); Patrick Stuart Claeys, Weston, FL (US); Joaquin Enrique Hing Batista, Miramar, FL (US); Gustavo Armando Suarez, Coral Springs, FL (US)

(21) Appl. No.: 19/638,033

(22) Filed: Apr. 2, 2026

Related U.S. Application Data
(60) Provisional application No. 63/782,583, filed on Apr. 2, 2025.

(51) Int. Cl. H05B 45/14

(52) U.S. Cl. CPC H05B 45/14

(57) ABSTRACT

An electronic device includes a housing, an electrical power interface, two or more power channels, a metering circuit, and a metering verification (MV) port. The power interface receives AC power from an external power source. The first power channel delivers power from the power interface to a first load. The second power channel delivers power from the power interface to a second, independent load. The metering circuit is arranged to measure AC power supplied through the second power channel. The MV port is coupled to an output of the metering circuit, accessible through an opening in the housing, and configured to (a) allow power to be delivered to the second load when the MV port is not being used for determining metering circuit accuracy and (b) bypass the second load and permit attachment of an external controlled load when the MV port is being used for determining metering circuit accuracy.

### CROSS-REFERENCE TO RELATED APPLICATIONS

The present application claims the benefit of and priority upon U.S. Provisional Patent Application No. 63/782,583, which was filed on Apr. 2, 2025, and is incorporated herein by this reference as if fully set forth herein

### TECHNICAL FIELD

The present disclosure relates generally to an electrically powered device that has multiple independent power channels, where at least one of the power channels is metered. More particularly, the present disclosure relates to such a device that requires metering accuracy verification.

### BACKGROUND

It is customary for public utilities to share physical plant. For example, residential power lines are commonly routed overhead by utility poles. In addition to these power distribution lines the utility poles also often support telephone and cable television lines. These other utilities pay the owner of the utility poles for access, and the power lines can also provide power to components of those other systems. One example of such components would include cascade amplifies for cable television networks, for example. The power provided to these other systems is metered and charged to the utility entity to which they belong.

A similar situation has arisen in urban and suburban locales, where streetlights can provide light at nighttime and their poles or lighting fixtures can support other equipment. For example, it is increasingly common to mount microcell telecommunication equipment to streetlight poles. Commercial electric power is provided to each streetlight by an underground line, and access to the power is provided via a connector or access box on the pole or lighting fixture. However, the device connected or attached to the streetlight may be owned and operated by a different entity than the owner of the streetlight. As a result, electric power provided to the attached device has to be accurately metered for invoicing. Use of an external power meter is not always practical.

### SUMMARY

This present disclosure is directed generally to inclusion of an externally accessible metering verification port in an AC-powered electronic device with multiple power channels to facilitate accuracy verification of the electronic device's power metering circuit for one or more of the power channels. The electronic device receives AC power from an external AC power source (such as a twist-lock electrical socket compliant with ANSI C136.41 located atop a streetlight luminaire) and directs the AC power along two or more paths or channels, one of which is configured to supply power to a primary load (e.g., a lighting controller and a ballast or an LED driver) and the other(s) of which is/are configured to supply power to one or more secondary loads, such as a processor-based computing platform of the electronic device and/or its associated accessories (e.g., cameras, motion sensors) connected to DC output power ports (e.g., Power over Ethernet (PoE) ports) of the electronic device) or a small cell (or remote radio head therefor) integrated into or electrically coupled to the electronic device. The metering verification port is configured to automatically isolate the power channel configured to supply power to the secondary load(s) to enable use of off-the-shelf wired and IR metering equipment for determining accuracy of the electronic device's metering circuit being used to measure AC power consumption for powering the secondary load(s).

In accordance with some embodiments of the present disclosure, an electronic device includes a housing, an electrical power interface, at least two electrical power channels, a metering circuit, and a metering verification port. The electrical power interface is configured through a boundary of the housing (e.g., through a top side, a sidewall, or a bottom side of the housing) to receive AC power from a power source external to the housing, such as a powered connector or junction box of a streetlight pole or lighting fixture. A first electrical power channel is located within the housing, coupled to the electrical power interface, and configured to deliver AC power to a first electrical load, which may be internal, external, or partially internal and partially external to the housing. A second electrical power channel is also located within the housing and coupled to the electrical power interface, but the second power channel is configured to deliver AC power to at least a second electrical load independent of the first electrical load. The second load (and other loads supplied by the second power channel) may be internal, external, or partially internal and partially external to the housing. The metering circuit is located within the housing and arranged to measure AC power supplied through the second electrical power channel, such as to power the second electrical load. The metering verification port is coupled to an output of the metering circuit and accessible through an opening in the housing. The metering verification port is configured to (a) allow power to be delivered through the second electrical power channel when the metering verification port is not being used for determining accuracy of the metering circuit and (b) bypass the second electrical power channel and permit attachment of an external controlled load when the metering verification port is being used for determining accuracy of the metering circuit.

According to some embodiments, the first electrical load includes a driver for a light emitting diode (LED) luminaire. According to other embodiments, the first electrical load is internal to the electronic device and includes a lighting controller.

According to some embodiments, the second electrical load is internal to the electronic device and includes a processor-based computing platform. According to other embodiments, the second electrical load is an accessory (e.g., camera, motion sensor, air quality sensor, etc.) connected to an externally accessible power port of the electronic device (e.g., a PoE port). According to further embodiments, the second electrical load includes a small cell access device, such as a microcell or picocell.

According to some embodiments, the metering verification port is positioned on a bottom side or underside of the housing. According to other embodiments, the metering verification port includes an infrared (IR) interface and/or a wired interface.

In accordance with some embodiments of the present disclosure, an electronic device includes a housing, an electrical power interface, at least two electrical power channels, a metering circuit, and a metering verification port. The electrical power interface is configured through a boundary of the housing (e.g., through a top side, a sidewall, or a bottom side of the housing) to receive AC power from a power source external to the housing, such as a powered connector or junction box of a streetlight pole or lighting fixture. A first electrical power channel is located within the housing, coupled to the electrical power interface, and configured to deliver AC power to a first electrical load, which may be internal, external, or partially internal and partially external to the housing. A second electrical power channel is also located within the housing and coupled to the electrical power interface, but the second power channel is configured to deliver AC power to at least a second electrical load independent of the first electrical load. The second load (and other loads supplied by the second power channel) may be internal, external, or partially internal and partially external to the housing. The metering circuit is located within the housing and arranged to measure AC power supplied through the second electrical power channel, such as to power the second electrical load. The metering verification port is coupled to an output of the metering circuit and accessible through an opening in the housing. The metering verification port is configured to (a) allow power to be delivered through the second electrical power channel when the metering verification port is not being used for determining accuracy of the metering circuit, (b) detect connection of a controlled electrical load thereto and responsively bypass the second electrical power channel to allow power to be delivered to the controlled load, and (c) detect disconnection of the controlled load and responsively re-allow power to be delivered thorugh the second electrical load.

According to some embodiments, the first electrical load includes a driver for a light emitting diode (LED) luminaire. According to other embodiments, the first electrical load is internal to the electronic device and includes a lighting controller.

According to some embodiments, the second electrical load is internal to the electronic device and includes a processor-based computing platform. According to other embodiments, the second electrical load is an accessory (e.g., camera, motion sensor, air quality sensor, etc.) connected to an externally accessible power port of the electronic device (e.g., a PoE port). According to further embodiments, the second electrical load includes a small cell access device, such as a microcell or picocell.

According to some embodiments, the metering verification port is positioned on a bottom side or underside of the housing. According to other embodiments, the metering verification port includes an infrared (IR) interface and/or a wired interface.

In accordance with some embodiments of the present disclosure, there is provided a method that includes providing an electronic device that includes a housing having an electrical interface configured to receive AC power from a power source external to the housing. There is a first electrical power channel located within the housing that is coupled to the electrical interface and that is configured to deliver AC power to a first electrical load, and there is a second electrical power channel located within the housing that is coupled to the electrical interface and that is configured to deliver AC power to at least a second electrical load independent of the first electrical load. The housing includes a metering circuit arranged to measure AC power supplied through the second electrical power channel, and the housing includes a metering verification port. The method further includes operating the electric device in a metered mode where the metering circuit meters power to the second electrical power channel. The method also includes connecting a metering verification connector to the metering verification port. The method further includes, responsive to connecting the metering verification connector to the metering verification port, operating the electronic device in a metering verification mode including automatically bypassing the second electrical power channel such that the output of the metering circuit is coupled to a conductor connector portion of the metering verification connector and thereby to a control load for verification of the metering circuit.

In accordance with some embodiments of the inventive disclosure, there is provided an electronic device that includes a housing and an electrical interface configured to receive AC power from a power source external to the housing. The device includes a metering verification port, and contains in the housing a plurality of electrical power channels. At least one electrical power channel of the plurality of electrical power channels is a non-metered electrical power channel, and at least one electrical power channel of the plurality of electrical power channels is a metered electrical power channel that has a metering circuit having an output. The output of the metering circuit is alternately coupled to an electrical load of the metered electrical power channel when the electronic device is operated in a metered mode, and to a connector of the metering verification port when the electronic device is operated in a metering verification mode. The electric device is configured to automatically change from the metered mode to the meter verification mode when a metering verification connector is connected to the metering verification port, and the electronic device is further configured to automatically resume the metered mode when the metering verification connector is disconnected from the metering verification port.

Although the present disclosure illustrates and describes an electrical device having multiple independent electrical power channels, at least one of which is not metered and at least one of which is metered, it is, nevertheless, not intended to be limited to the details shown because various modifications and structural changes may be made therein without departing from the spirit of the disclosure and while remaining within the scope and range of equivalents of the claims. Additionally, well-known elements will not be described in detail or will be omitted so as not to obscure the relevant details of the present disclosure.

Features that are considered characteristic of the invention are set forth in the appended claims. As required, detailed embodiments of an electronic device are disclosed herein; however, it is to be understood that the disclosed embodiments are merely exemplary and the electronic device may be embodied in various forms. Therefore, specific structural and functional details disclosed herein are not to be interpreted as limiting, but merely as a basis for the claims and as a representative basis for teaching one of ordinary skill in the art to variously employ the claimed invention in appropriately detailed structures. Further, the terms and phrases used herein are not intended to be limiting; but rather, to provide an understandable description of the disclosure. While the specification concludes with claims defining the features of the invention, it is believed that the claimed invention will be better understood from a consideration of the following description in conjunction with the drawing figures, in which like reference numerals are carried forward. The figures of the drawings are not drawn to scale.

The terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time.

As used in this description, unless otherwise specified, azimuth or positional relationships indicated by terms such as “up”, “down”, “left”, “right”, “inside”, “outside”, “front”, “back”, “head”, “tail,” and so on, are relationships based on the drawings, which are only used to facilitate description of exemplary embodiments of the present disclosure, but not to indicate or imply that devices or components must have a specific azimuth, or be constructed or operated in the specific azimuth, which thus cannot be understood as a limitation to the embodiments of the present invention. Furthermore, terms such as “first”, “second”, “third,” “primary,” secondary,” and so on are only used for descriptive and differentiation purposes, and are not to be construed as indicating or implying relative importance.

As used in this description, unless otherwise clearly defined and limited, terms such as “installed”, “coupled”, “connected” should be broadly interpreted, for example, it may be fixedly connected, or may be detachably connected, or integrally connected; it may be mechanically connected, or may be electrically connected; it may be directly connected, or may be indirectly connected via an intermediate medium. As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. In this document, the term “longitudinal” should be understood to mean in a direction corresponding to an elongated direction of the device. Those skilled in the art can understand the specific meanings of the above-mentioned terms in the embodiments of the present disclosure according to the specific circumstances.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present disclosure.

FIG. 1 is an electrical block diagram of an electronic device having multiple electrical power channels with power metering of at least one channel and configured in a first, normal operating state, in accordance with some exemplary embodiments of the present disclosure.

FIG. 2 is the electrical block diagram of the electronic device of FIG. 1 illustrating the electronic device in a second state during meter accuracy verification, in accordance with some exemplary embodiments of the present disclosure.

FIG. 3 shows a bottom perspective view of an electronic device having an exemplary metering verification port, in accordance with some exemplary embodiments of the present disclosure.

FIG. 4 shows an enlarged view of the exemplary metering verification port forming part of the electronic device of FIG. 3.

FIG. 5 shows an exemplary electronic device installed on a streetlight luminaire, in accordance with some exemplary embodiments of the present disclosure.

FIG. 6 is a logic flow diagram of steps performed to verify the accuracy of a metering circuit in an electronic device configured for delivering power to multiple independent electrical loads, in accordance with some exemplary embodiments of the present disclosure.

### DETAILED DESCRIPTION

To solve the problem of metering power consumption and verifying the meter accuracy of a device, the device is provided with a metering verification port that allows coupling of an externally controlled load to the internal metering circuit of the device. When the metering verification port is not being used, it presents as a short-circuit pass-through to the internal load (circuitry) of the device, and when a meter verification testing unit is connected to the meter verification port the load being metered is bypassed so that a controlled load can be externally coupled to the metering circuit to verify the accuracy of the metering circuit.

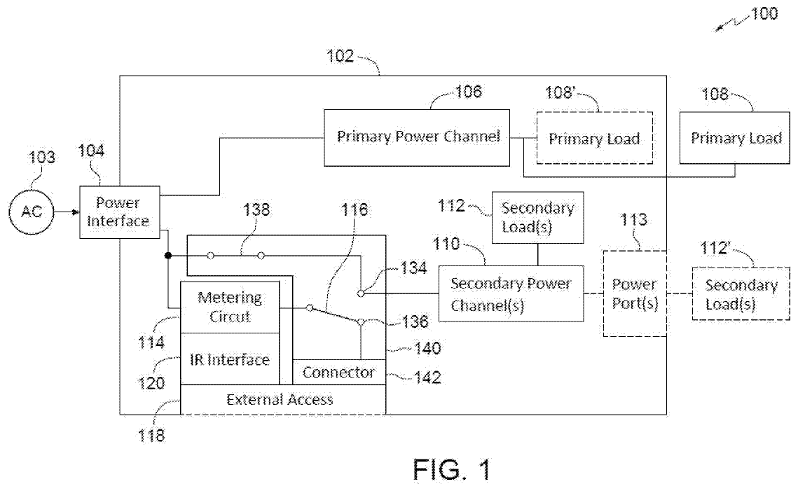

FIG. 1 is an electrical block diagram of an electronic device 100 having multiple independent power channels with power metering verification of at least one channel, in accordance with some embodiments of the present disclosure. The device includes a housing 102, an electrical interface 104 configured to receive alternating current (AC) electrical power from a power source 103 external to the housing 102, at least two wholly or partially independent electrical power channels 106, 110 coupled to the electrical interface 104 and configured to deliver AC or DC power, as appropriate, to respective independent electrical loads 108, 112, a metering circuit 114 arranged to measure AC power supplied to one or more but not all of the electrical power channels 108, 112, and a metering verification port coupled to the output of the metering circuit 114 and accessible through an opening 118 in the housing 102. According to some exemplary embodiments, the AC power source 103 is a streetlight having an externally accessible electrical socket (e.g., a twist-lock electrical socket compliant with ANSI C136.41 located atop the streetlight's luminaire) and the electrical interface 104 is a complementary electrical connector coupled through a wall of the housing 102. Each electrical power channel 106, 110 is configured to deliver power to a respective electrical load 108, 112, where an electrical load may include one or more power consuming devices. Each electrical load 108, 112 may include one or more devices that consume DC power or AC power. Power is delivered to each electrical load 108, 112 through a respective electrical power channel 106, 110 that includes appropriate electrical circuits and other electrical considerations for supplying AC power or DC power to the load 108, 112 depending on the load's power needs (AC power or DC power). For example, where the load 108 is a DC load that includes, for example, one or more integrated circuits, the associated electrical power channel 106, 110 may include an AC-to-DC power supply, voltage regulator(s), filters, voltage divider(s), surge protector or other transient suppressor, stray voltage protection, appropriate grounding and/or shielding, and other typical electrical features for delivering DC power to the load. Where the load 108 is an AC load that includes, for example, an AC motor or system, the associated electrical power channel 106, 110 may include a transformer, filtering circuitry, regulators, and so forth to delivering AC power to the load. For the remainder of this disclosure, the description will focus on delivery of DC power to the electrical loads 108, 112 but measurement of the AC power consumed from the AC power source 103 to produce and deliver the DC power to the loads 108, 112.

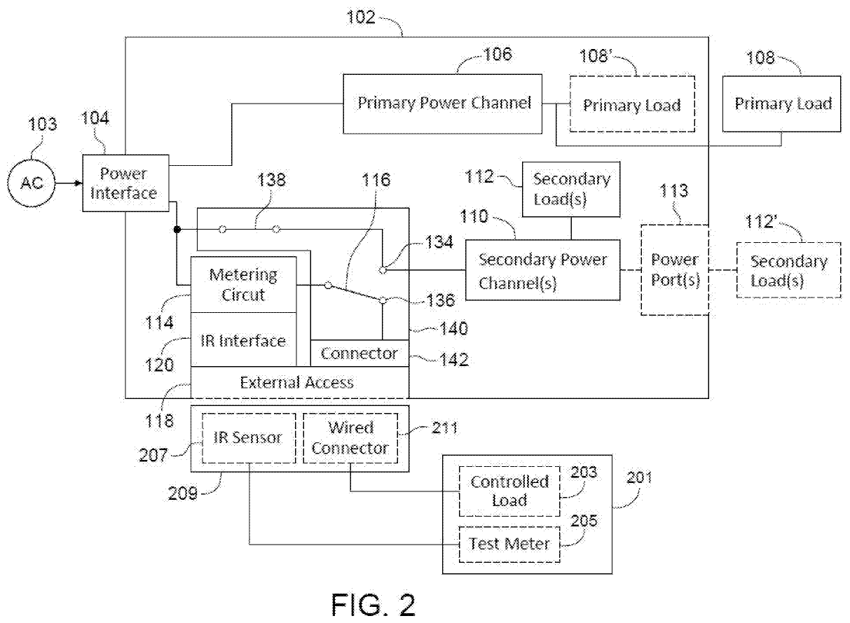

The electronic device's electrical power channels 106, 110 supply power to electrical loads 108, 112 that are independent of each other. According to an exemplary embodiment in which the primary load 108 of the electronic device is a lighting controller and associated LED streetlight, the secondary load 112 of such device may be a computing subsystem or small cell resident within the electronic device housing 102, which enables the electronic device 100 to provide a multi-function computing or processing platform. The electronic device 100 may also include externally accessible DC power ports, such as Power over Ethernet (PoE) ports, permitting the attachment of accessories, such as cameras, motion detectors, Internet of Things (IoT) sensors, and other electronic devices as part of the secondary load 112 or as their own separate secondary loads 112 requiring their own secondary electrical power channels 110. As illustrated in FIGS. 1 and 2, the primary load 108 in one exemplary embodiment is positioned outside the housing 102 of the electronic device 100 (e.g., where the load 108 is a LED streetlight luminaire) but such load 108′ may be positioned within the housing 102 of the electronic device 100 in an alternative exemplary embodiment. As additionally illustrated in FIGS. 1 and 2, the secondary load 112 in one exemplary embodiment is positioned inside the housing 102 and as part of the electronic device 100 (e.g., where the load 112 is a computing processing platform or a small cell) but such load 112′ may be positioned outside the housing 102 of the electronic device 100 in an alternative exemplary embodiment.

According to some embodiments of the present disclosure, the metering circuit 114 is arranged to measure the AC power supplied by the AC power source 103 to the secondary electrical load through the secondary electrical power channel 110. The metering circuit 114 can be configured in accordance with known and standardized electric power metering technologies, and can include an infrared interface 120. There is also a metering verification port 140 coupled to an output of the metering circuit, and which is accessible through an external opening 118 of the housing 102. The metering verification port 140 is configured to present a short circuit to the second electrical power channel 110 and to the second electrical load 112 when the metering verification port 140 is not being used for determining accuracy of the metering circuit 114. The metering verification port 140 is further configured to bypass the second electrical power channel 110 and the second electrical load 112 when the metering verification port 140 is used to determine the accuracy of the metering circuit 114.

In FIG. 1, the metering verification port 140 is not being used to verify the accuracy of the metering circuit 114. Accordingly, the metering verification port is configured such that the AC power is routed from the electrical interface 104 directly through the metering circuit 114 to the second electrical power channel 110 and second electrical load 112. This operation is represented by a pair of bypass switches 116, 138 of the metering verification port 140. In normal operation, as represented in FIG. 1, a first bypass switch 138 is opened, and the second bypass switch 116 connected the output of the metering circuit 114 to the second electrical power channel 110 and second electrical load 112 via pole 134. The pole 134 can be a physical pole, or an electronic connection if the bypass switch 116 is an electronic switch. In this configuration all power used by the second electrical power channel is metered by the metering circuit 114. The amount of power consumed by the second electrical power channel 110 can periodically be read via the IR interface 120 through the external opening 118. At the external opening 118, there can be both an infrared interface 120 exposed as well as a wired connector 142 that includes terminations of conductors (wiring) that can be connected to with a corresponding connector.

In some embodiments, the first electrical power channel 106 can be configured to power a luminaire or streetlight. The second electrical power channel 110 can include circuitry, including the second electrical load 112, for a microcell communications system, which allows mobile communication and computing devices to wirelessly connect to radio channels provided by the microcell communication system, and to a wide area communications network via the microcell communication system.

FIG. 2 is system block diagram of the electronic device 100 coupled to an exemplary meter verification device 201. Although the metering circuit 114 can continue to operate over time, its accuracy may be verified periodically through the external access opening 118. Also, if a utility service fee is disputed, the accuracy of the metering circuit 114 may be verified/checked. To verify the accuracy of the metering circuit 114, the external meter verification device 201 is used. One illustrative example of the meter verification device 201 is the DTS-2990 desktop meter station or the FTS-2990 field meter test station manufactured by Tesco, Inc. Other equivalent meter stations or devices may be used to verify the accuracy of the metering circuit 114. The exemplary meter verification device 201 typically includes a controlled load 203, which is a known and calibrated load, and a calibrated test meter 205. The test meter 205 is coupled to an IR sensor 207 which is part of a connector 209 that fits into the external port 118. There is also a wired connector portion 211 that interfaces into the connector 142 of the device 100.

When the connector 209 is inserted into the external access opening 118, the wired connector portion 211 connects with the wired connector 142 of the device 100, and the IR sensor 207 aligns with the IR interface 120. When the wired connector portion 211 mates with the connector 142 of the device 100, several conductors mate together, one of which connects pole 136 of bypass switch 116 to the control load 130. The other conductors cause the bypass switches 116, 138 to change switch states such that bypass switch 138 is closed, connecting the electrical interface 104 directly to pole 134 and thereby to the second electrical power channel, thereby ensuring that the second electrical power channel remains powered during the metering circuit verification. Likewise, the conductor connections cause bypass switch 116 to switch states, bypassing the second electrical power channel 110. In this configuration, the metering circuit 114 remains connected to the electrical interface 104, but the output of the metering circuit 114 is now connected to the control load 130 of the meter verification device 128 for a meter verification process. The meter verification process is well known, and involves counting pulses from the IR interface 120 via the IR pickup 124 and IR detector 132. Each pulse is emitted by the metering circuit 114 through the IR interface 120 when the metering circuit 114 has metered a specified amount of power. This is compared to the actual power through the control load 130 to gauge the accuracy the metering circuit 114. When the connector 122 is removed, the wired connector portion 211 will be disconnected from the connector 142 off the device 100, and the bypass switches 116, 138 will revert to the state shown in FIG. 1 and metered operation of the device will continue thereafter.

The use of two bypass switches 116, 138 allows the second electrical power channel 110 to continue operating during the meter verification process. If the operation of the second electrical power channel 110 can be interrupted during the meter verification process, then only bypass switch 116 is necessary, and bypass switch 138 can be omitted.

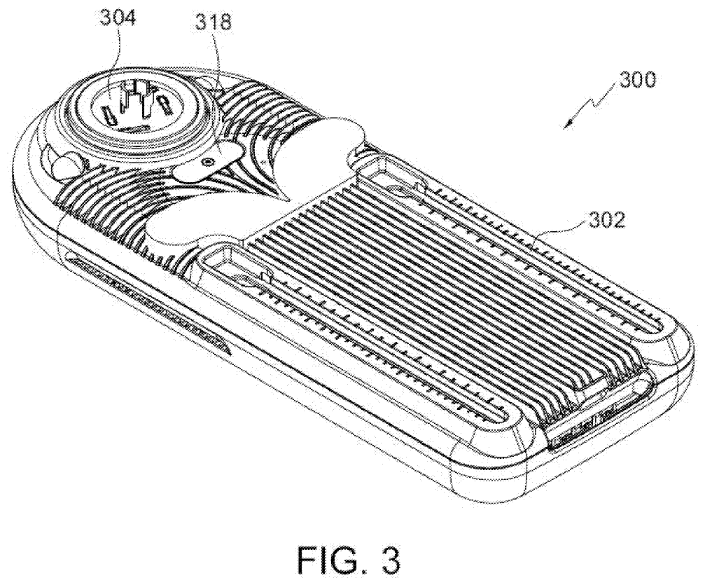

FIG. 3 shows a bottom perspective view of an alternative exemplary electronic device 300 having a metering verification port 306, in accordance with some embodiments of the present disclosure. The electronic device 300 incudes a lighting control circuit to control dimming and other operations of a light fixture (e.g., streetlight luminaire) and can further include circuitry and components, receiving AC power over a separate, independent electrical power channel, of a computing platform that uses a wireless link to send various types of data to (e.g., data from sensors, such as cameras, motion sensors, and so forth attached to or part of the electronic device 300) and receive control signals and software updates/upgrades from a remote control system, such as a cloud-based web application. The metering verification port 306 is shown with a cover in place to protect the connector in the port from weather and wildlife.

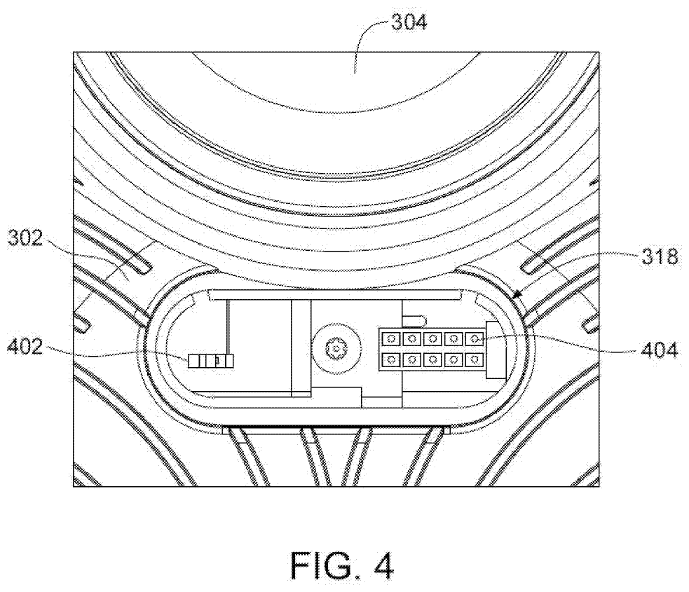

FIG. 4 shows a detail of a metering verification port 306, with the cover removed, in accordance with some embodiments of the inventive disclosure. The port 306 is positioned adjacent the electrical connector 304 at the top side of the housing 302. With the cover removed, the IR interface 120 (e.g., as implemented via an IR light emitting diode (LED) 402) and the wired connector 142 (e.g., as implemented as a multipin connector 404) are exposed. A mating connector (e.g. connector 122) can be fit into the port 306, aligning an IR pickup with the IR interface 402 and connecting a conductor connector portion into connector 404. This arrangement allows a technician to easily connect a meter verification device to the port to verify the accuracy of the metering circuit.

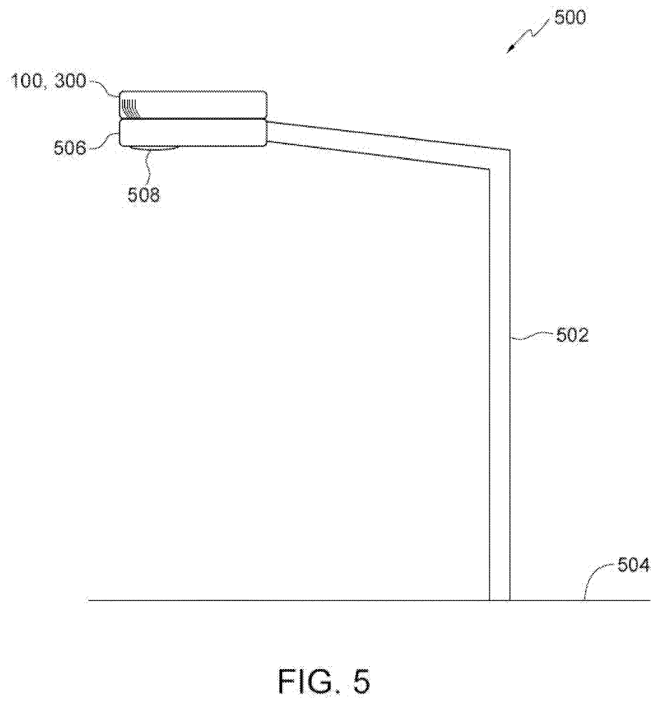

FIG. 5 shows an example of a lighting control device 510 deployed on a luminaire system 500, where the lighting control device includes a metering circuit, in accordance with some embodiments of the inventive disclosure. The luminaire system 500 includes a pole 502 the extends upwards from a ground surface 504. The luminaire system 500 can be used to light streets and/or walkways, such as sidewalks. At the upper end of the pole 502 is a light unit 506 including a light source 508 which points downward to emit light towards the ground surface 504. An electrical device 100, 300, such as illustrated in FIGS. 1-3, is connected through its electrical connector 104, 304 to an electrical socket (not shown) on top of the light unit 506. The primary electrical power channel 106 of the electrical device 100, 300 receives power from the light unit 506 and supplies power to a lighting control section of the lighting controller 510 to control when the light source 508 is turned on and turned off, by sensing daytime versus night time. The lighting controller 510 can also include a system that is not involved with the control or operation of the light unit 510, such as a microcell wireless communication system, which would be the equivalent of the second electrical load 112. Thus, the microcell wireless communication system can operate independently of the light unit, and be billed separately for power consumption via the metering circuit (e.g. 114). The metering circuit's accuracy can be verified via the metering verification port as needed.

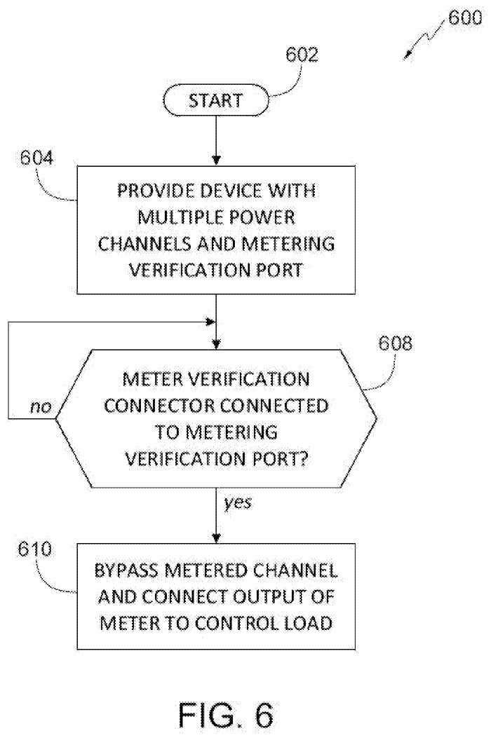

FIG. 6 is a flow chart diagram of a method of verifying the accuracy of a metering circuit in a device having multiple independent electrical power channels, in accordance with some embodiments of the inventive disclosure. At the start 602 of the method 600, a device such as device 100 is provided, including multiple independent internal electrical power channels, each with their own electrical load. At least one of those independent electrical power channels is metered for billing purposes. The device therefore includes a metering verification port to allow for the connection of a meter verification device. Thus, in step 604 the device is provided and installed for operation. In step 606 the device commences metered operation, meaning that the power consumption of the at least one metered independent electrical power channel is metered; power for the metered channel passes through the metering circuit, or a sensor of the metering circuit to the electrical power channel being metered. there is also at least one non-metered electrical power channel in the device, that is independent of the metered electrical power channel(s). In step 608 a metering verification device can be connected at the metering verification port. While no such connection is made, the method simply continues metered operation in step 606. But when the metering verification connector (e.g., connector 122) is connected to the metering verification port, as in step 610, the metered electrical power channel is automatically bypassed, meaning the output of the metering circuit is then connected to the connector of the metering verification port, and only to the connector of the metering verification port. The metered channel can continue operating without being metered during the metering verification process, which only takes a few minutes of time to complete. In step 612, when the metering verification connector is removed from the metering verification port, metered operation will then resume in step 606, and the bypass is automatically removed. Metered operation continues until the device is shut off or until the next metering verification is performed.

A device including multiple independent internal electrical power channels has been disclosed in which at least one of the electrical power channels is metered so that an appropriate electric power bill can be charged to the owner/operator of that independent electrical power channel. Since not all of the independent power channels are commonly billed, placing a meter at the electric power interface of the device (e.g. the main power connector) would meter all of the channels rather than only the channel being billed separately. This is solved by including a metering circuit in the device that meters the power consumption of an electric power channel operated in the device. To access the meter, a port is provided in the housing of the device which allows a metering verification connector to be connected to the device. When the metering verification connector is connected at the port, the metered electric power channel is automatically bypassed such that the output of the metering circuit is connected to the port, rather than to the metered electric power channel. The accuracy of the metering circuit can then be tested with control load.

The claims appended hereto are meant to cover all modifications and changes within the scope and spirit of the present invention.

What is claimed is:

1. An electronic device comprising:
a housing;
an electrical power interface configured to receive alternating current (AC) power from a power source external to the housing;
a first electrical power channel located within the housing and coupled to the electrical power interface, the first electrical power channel configured to deliver power to a first electrical load;
a second electrical power channel located within the housing and coupled to the electrical power interface, the second electrical power channel configured to deliver power to at least a second electrical load independent of the first electrical load;
a metering circuit located within the housing and arranged to measure AC power supplied through the second electrical power channel; and
a metering verification port coupled to an output of the metering circuit and accessible through an opening in the housing, the metering verification port configured to (a) allow power to be delivered to the second electrical load when the metering verification port is not being used for determining accuracy of the metering circuit and (b) bypass the second electrical load and permit attachment of an externally-applied controlled load when the metering verification port is being used for determining accuracy of the metering circuit.

2. The electronic device of claim 1, wherein the first electrical load includes a driver for a light emitting diode (LED) luminaire.

3. The electronic device of claim 1, wherein the first electrical load is internal to the electronic device and includes a lighting controller.

4. The electronic device of claim 1, wherein the second electrical load is internal to the electronic device and includes a processor-based computing platform.

5. The electronic device of claim 1, wherein the second electrical load is an accessory connected to an externally accessible power port of the electronic device.

6. The electronic device of claim 1, wherein the metering verification port is positioned on a bottom side of the housing.

7. The electronic device of claim 1, wherein the metering verification port includes an infrared (IR) interface.

8. The electronic device of claim 1, wherein the second electrical load includes a small cell.

9. An electronic device comprising:
a housing;
an electrical power interface configured to receive alternating current (AC) power from a power source external to the housing;
a first electrical power channel located within the housing and coupled to the electrical power interface, the first electrical power channel configured to deliver power to a first electrical load;
a second electrical power channel located within the housing and coupled to the electrical power interface, the second electrical power channel configured to deliver power to at least a second electrical load independent of the first electrical load;
a metering circuit located within the housing and arranged to measure AC power supplied through the second electrical power channel; and
a metering verification port coupled to an output of the metering circuit and accessible through an opening in the housing, the metering verification port configured to (a) allow power to be delivered to the second electrical load when the metering verification port is not being used for determining accuracy of the metering circuit, (b) detect connection of a controlled electrical load thereto and responsively bypass the second electrical load to allow power to be delivered to the controlled load, and (c) detect disconnection of the controlled load and responsively re-allow power to be delivered to the second electrical load.

10. The electronic device of claim 9, wherein the first electrical load includes a driver for a light emitting diode (LED) luminaire.

11. The electronic device of claim 9, wherein the first electrical load is internal to the electronic device and includes a lighting controller.

12. The electronic device of claim 9, wherein the second electrical load is internal to the electronic device and includes a processor-based computing platform.

13. The electronic device of claim 9, wherein the second electrical load is an accessory connected to an externally accessible power port of the electronic device.

14. The electronic device of claim 9, wherein the metering verification port is positioned on a bottom side of the housing.

15. The electronic device of claim 9, wherein the metering verification port includes an infrared (IR) interface.
